(19) United States
(12) Patent Application Publication
(10) Pub. No.: US 2016/0144894 A1
(43) Pub. Date: May 26, 2016

(54) VEHICLE WHEEL TWIST SYSTEM FOR SMALL OVERLAP FRONTAL COLLISIONS

(71) Applicants: Hyundai America Technical Center, Inc., Superior Township, MI (US); Hyundai Motor Company, Seoul (KR); Kia Motors Corporation, Seoul (KR)

(72) Inventor: Bavneet Brar, Ann Arbor, MI (US)

(21) Appl. No.: 14/548,732

(22) Filed: Nov. 20, 2014

(51) Int. Cl. B62D 15/02; B60R 21/0136

(52) U.S. Cl. CPC B62D 15/025; B60R 21/0136; B60R 2021/0004

(57) ABSTRACT

In one embodiment, a system is disclosed that includes a telescopic linkage coupled to a wheel of a vehicle. The system also includes a sensor that detects a small overlap frontal collision of the vehicle. The system further includes a controller coupled to the sensor and to the telescopic linkage. The controller actuates the telescopic linkage in response to receiving an indication from the sensor that a small overlap frontal collision of the vehicle is detected. When actuated by the controller, the telescopic linkage rotates the wheel.

### BACKGROUND

(a) Technical Field

The present disclosure generally relates to a system for distributing an impact force in a vehicle. In particular, techniques are disclosed whereby impact forces are redirected away from an occupant compartment of the vehicle.

(b) Background Art

Many modern vehicles are equipped with a number of features that redirect and/or absorb impact forces during a crash. For example, some vehicles are designed with a “crumple zone” that absorbs some of the impact forces during a head-on collision. Generally speaking, a crumple zone operates by sacrificing portions of the vehicle to redirect impact forces away from passenger compartment of the vehicle. Thus, on impact, a vehicle may appear to “crumple,” while still maintaining the structural integrity of the passenger compartment.

In addition to employing crumple zones, modern vehicles are also typically equipped with features designed to minimize and/or distribute impact forces on passengers. Passenger restraints such as seatbelts, for example, help to secure a passenger to his or her seat during impact. Airbags may also be deployed during an impact to help cushion a passenger from the impact. In some vehicles, airbags may be located both in the front of the vehicle (i.e., for use during a head-on collision) and along the vehicle's doors (i.e., for use during a side impact to the vehicle).

One area of interest that has emerged in recent years is the study of small overlap frontal collisions. As opposed to a fully head-on collision, a small overlap frontal collision typically involves only a small portion of the front of the vehicle impacting another object. For example, the Insurance Institute for Highway Safety (IIHS) has promulgated a standardized test for small overlap frontal collisions in which only 25%+/−1% of the width of the front of a vehicle impacts a barrier. Such an impact may have significantly different effects on the vehicle than if the vehicle impacted the barrier directly. In other words, measures taken to address other types of impacts (e.g., a full frontal collision, a side impact, etc.) may not fully address small overlap frontal collisions.

In order to solve the problems in the related art, there is a demand for the development of techniques that redirect impact forces in a controlled manner during certain impact conditions, such as during a small overlap frontal collision.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides systems and methods that provide minimal intrusion into the passenger compartment of the vehicle during a small overlap frontal collision of a vehicle. In particular, techniques are disclosed whereby the front wheel closest to the impact is forcibly rotated during the impact, thereby redirecting the force of the impact.

In one embodiment, the present invention provides a system that includes a telescopic linkage coupled to a wheel of a vehicle. The system also includes a sensor that detects a small overlap frontal collision of the vehicle. The system further includes a controller coupled to the sensor and to the telescopic linkage. The controller actuates the telescopic linkage in response to receiving an indication from the sensor that a small overlap frontal collision of the vehicle is detected. When actuated by the controller, the telescopic linkage rotates the wheel.

In some aspects the telescopic linkage rotates an end of the wheel that is closer to the collision in a direction towards the vehicle when actuated. In another aspect, the telescopic linkage is a pyrotechnic linkage. The linkage may include a housing that defines an internal aperture, an actuator arm coupled to the wheel and located within the internal aperture, a piston coupled to the actuator arm, an ordinance located within the internal aperture of the housing, and an igniter operable to ignite the ordinance. In one aspect, the controller is an airbag control unit. In a further aspect, the system may include a steering rod that links the wheel to a steering gear box. The telescopic linkage disconnects the steering rod from the steering gear box when actuated. In another aspect, the telescopic linkage is actuated within 20 milliseconds of the sensor detecting the small overlap frontal collision of the vehicle. In yet another aspect, the wheel rotates about an axis defined by a control arm connected to the wheel.

In another embodiment, a method is disclosed. The method includes receiving, at controller, impact data from one or more sensors of a vehicle. The method also includes detecting, by the controller, a small overlap frontal collision of the vehicle. The method further includes actuating, by the controller, a telescopic linkage coupled to a wheel of the vehicle. When actuated, the telescopic linkage rotates the wheel.

In another embodiment, a system is disclosed. The system includes sensing means for sensing a small overlap frontal collision of a vehicle. The system also includes forcing means for forcing a wheel of the vehicle to turn. The system further includes controlling means for actuating the forcing means in response to the sensing means sensing the small overlap frontal collision of the vehicle.

In some aspects, the system also includes steering means for steering the wheel. In another aspect, the system further includes disconnecting means for disconnecting the steering means from the wheel. In another aspect, the system includes retaining means for coupling the wheel to the vehicle while the forcing means is actuated.

Advantageously, the systems and methods described herein allow a wheel of a vehicle to be rotated forcibly in response to detecting a small overlap frontal collision, thereby removing a potential force path for the impact that would otherwise direct the force into the side of the vehicle and potentially impinge on the passenger compartment of the vehicle.

### BRIEF DESCRIPTION OF THE DRAWINGS

The above and other features of the present invention will now be described in detail with reference to certain exemplary embodiments thereof illustrated the accompanying drawings which are given herein below by way of illustration only, and thus are not limitative of the present invention, and wherein:

FIGS. 1A-1D are illustrations of various frontal collisions of a vehicle;

FIGS. 2A-2B are diagrams illustrating a steering system for a vehicle;

FIGS. 3A-3C are diagrams illustrating a wheel twist system for small overlap frontal collisions;

FIGS. 4A-4B are diagrams illustrating a small overlap frontal collision on a vehicle equipped with a wheel twist system;

FIGS. 5A-5B are diagrams illustrating the underside of a vehicle during small overlap frontal collisions;

FIGS. 6A-6B are diagrams illustrating a vehicle passenger compartment during small overlap frontal collisions; and

FIG. 7 illustrates simulated impact intrusion results for a vehicle.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present disclosure will be described so as to be easily embodied by those skilled in the art.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that the below methods are executed by at least one controller. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components.

The present invention provides a system for distributing an impact force in a vehicle. Particularly, in the present disclosure, in order to fundamentally solve the problem of small overlap frontal collisions, systems and methods are disclosed whereby a wheel of the vehicle is forcibly rotated in response to detecting a small overlap frontal collision, thereby preventing the transference of force into the door area of the vehicle. Said differently, the techniques herein allow a wheel to be twisted so as not to impinge on the occupant compartment of the vehicle during a small overlap frontal collision.

According to the present invention, a system is disclosed that includes a telescopic linkage coupled to a wheel of a vehicle. The system also includes a sensor that detects a small overlap frontal collision of the vehicle. The system further includes a controller coupled to the sensor and to the telescopic linkage. The controller actuates the telescopic linkage in response to receiving an indication from the sensor that a small overlap frontal collision of the vehicle is detected. When actuated by the controller, the telescopic linkage rotates the wheel.

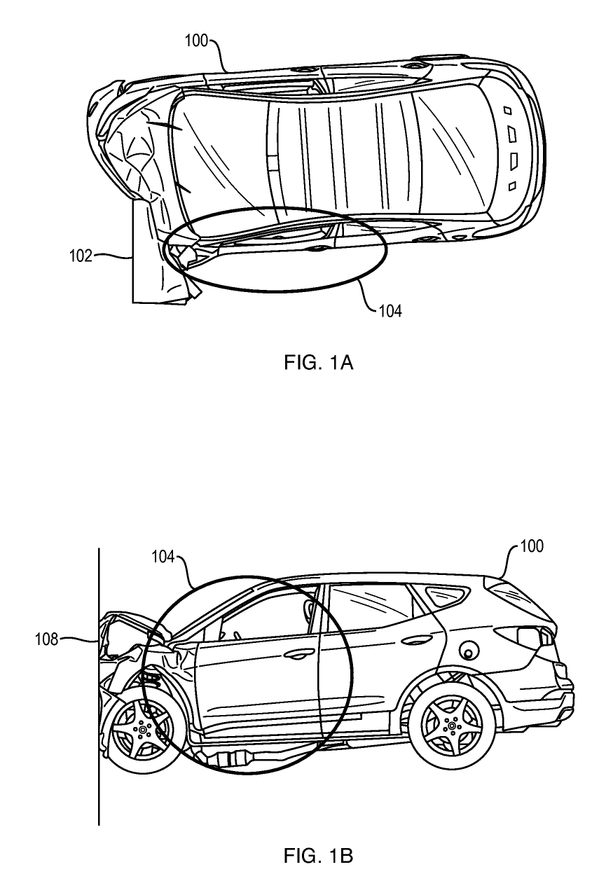

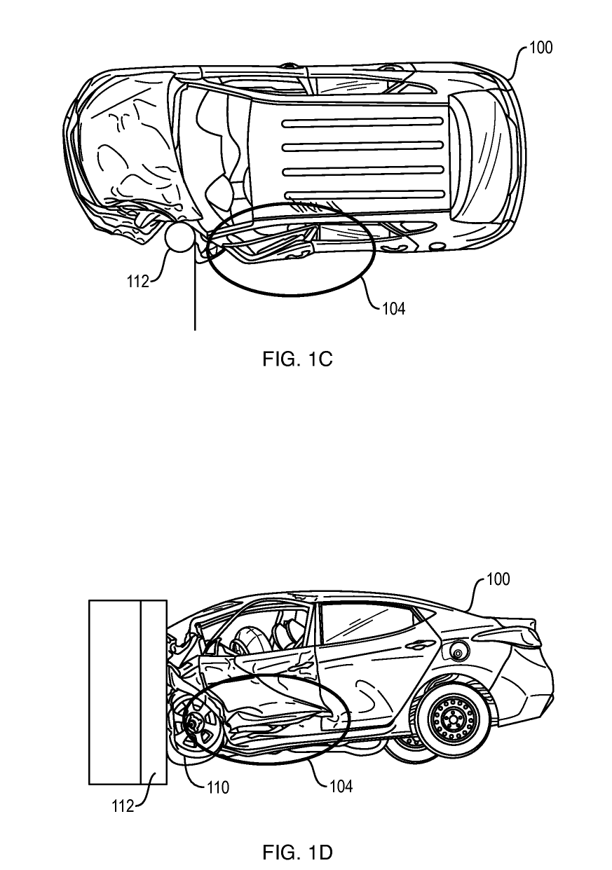

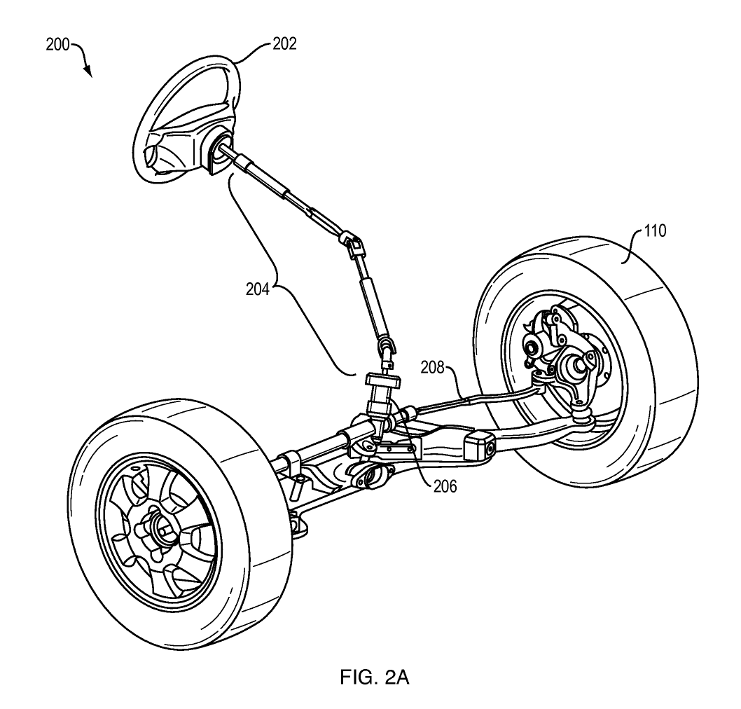

Referring now to FIGS. 1A-1D, various types of frontal vehicle collisions are shown. FIG. 1A illustrates a 40% offset frontal collision to a typical vehicle 100. In this scenario, vehicle 100 impacts an object 102 at approximately 40% of the width of the front of vehicle 100. FIG. 1B illustrates a full frontal collision to vehicle 100. In contrast to the scenario illustrated in FIG. 1A, 100% of the frontal width of vehicle 100 impacts a barrier 108 in the scenario illustrated in FIG. 1B. In both scenarios, vehicle 100 remains relatively unaffected within door region 104. This is due to most modem vehicles being designed to compensate for substantially frontal collisions. In other words, one or both of the front structural rails of vehicle 100 may absorb and distribute the impact force in a 40% offset frontal or full frontal collision, respectively. Thus, the underbody structure of vehicle 100 may be configured to reduce the transferal of the impact force into the passenger compartment of vehicle 100 (e.g., by providing a frontal crumple zone).

In FIGS. 1C-1D, a small overlap frontal collision involving vehicle 100 is shown. In this scenario, only a marginal portion of the frontal width of vehicle 100 impacts an object 112. For crash testing purposes, this width is typically 20%+/−1%. However, it is to be appreciated that an actual collision may occur at any percentage of the frontal width of a vehicle (e.g., anywhere from less than 1% of the frontal width of the vehicle to 21% of the frontal width of the vehicle). In contrast to the scenarios illustrated in FIGS. 1A-1B, the small overlap frontal collision shown in FIGS. 1C-1D demonstrates significant door deformation of vehicle 100 within door region 104. This is because vehicle 100 impacts object 112 in such a way that object 112 misses the front rails of the frame of vehicle 100. Consequently, the impact force generated during the collision with object 112 is transferred into door region 104 via wheel 110 and potentially impinging upon the passenger compartment of vehicle 100. In particular, the impact force is transferred from wheel 110 into the door hinge pillar and door sill of vehicle 100. In other words, wheel 110 may provide a force path during a small overlap frontal collision that transfers the impact force to door region 104.

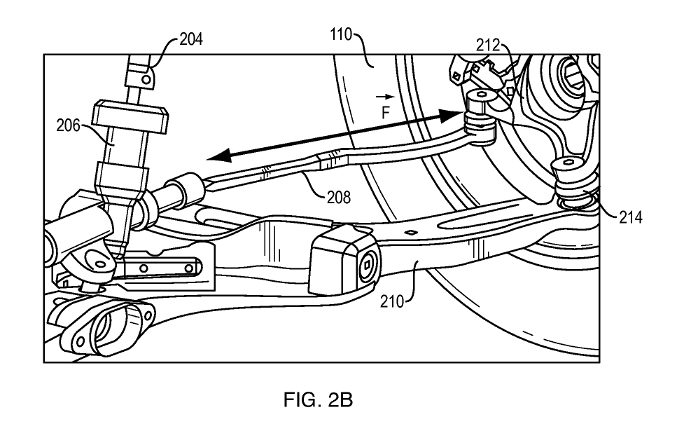

FIGS. 2A-2B illustrate a steering system 200 for a vehicle, according to various embodiments. As shown in FIG. 2A, front wheel 100 may be coupled to a steering wheel 202 via a steering linkage 208, gear box 206, and steering column 204. When steering wheel 202 is rotated, the rotational force is transferred to gear box 206 via steering column 204. In various implementations, steering column 204 may be a fixed shaft or may comprise any number of linked shafts (e.g., via universal joints, etc.), thereby allowing steering wheel 202 to be located at any position relative to gear box 206.

As shown in greater detail in FIG. 2B, gear box 206 translates the rotational force from steering column 204 into a pulling or pushing force F that is transferred to steering linkage 210. For example, gearbox 212 may use a rack and pinion mechanism or any other suitable mechanism for translating the rotational force from steering column 204 into a force F. In some embodiments, a steering pump (not shown) may provide hydraulic pressure to gearbox 206, thereby enhancing the pulling or pushing force F on steering linkage 208. Notably, mount 212 of wheel 110 may be coupled to both linkage 210 and to a control arm 210. In particular, when force F is applied to mount 212 via steering linkage 210, wheel 204 may rotate about a bushing 214 that couples mount 212 to control arm 210. The direction of rotation is thus a function of the direction of force F (e.g., pulling mount 212 will cause wheel 204 to rotate in one direction and pushing on mount 212 will cause wheel 204 to rotate in the opposite direction). As would be appreciated, the steering system 200 shown is exemplary only and other steering configurations may be used within the scope of the present invention.

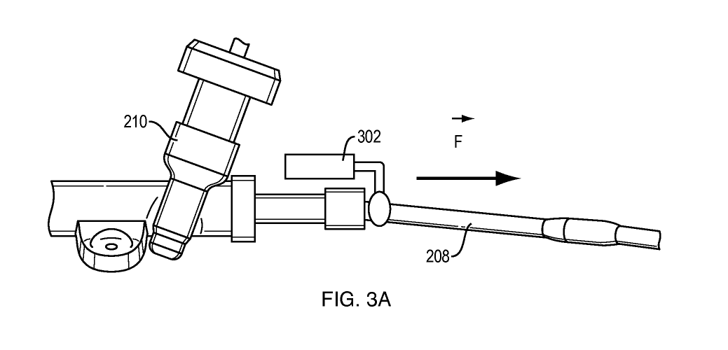

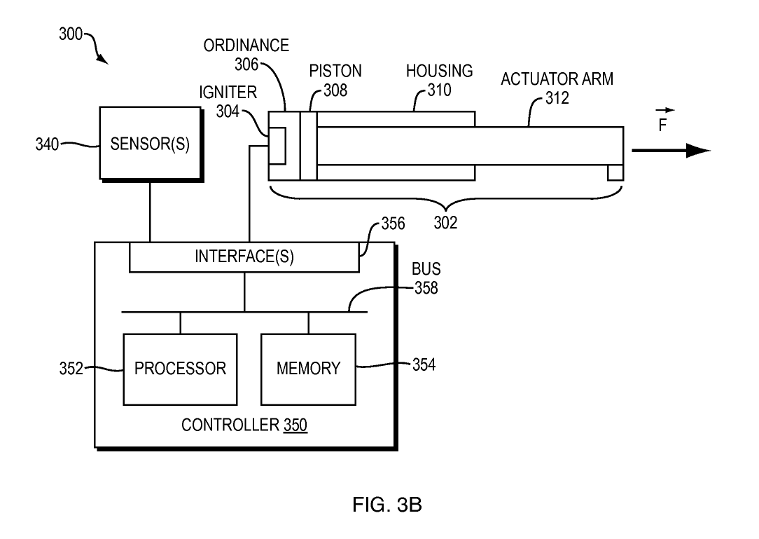

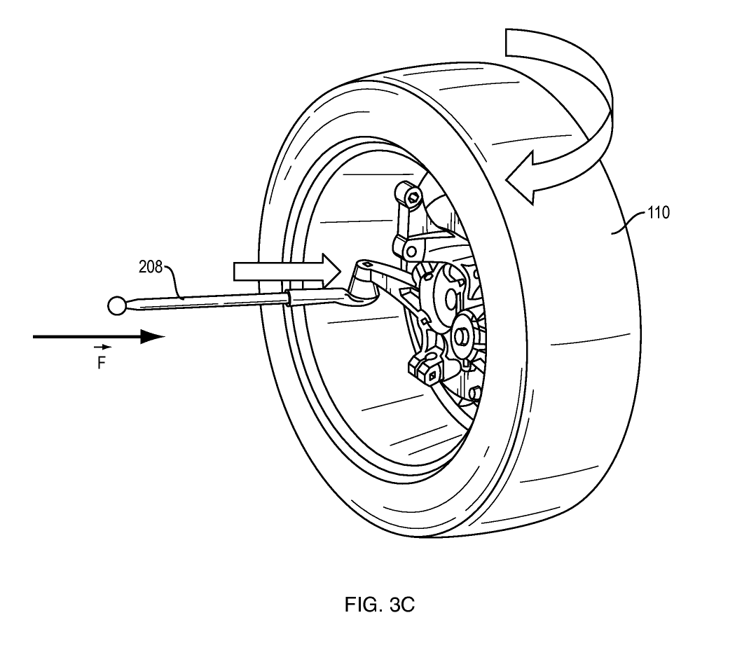

FIG. 3A illustrates an example forcing mechanism 302 that may be coupled to steering linkage 210. In various embodiments, forcing mechanism 302 may be operable to provide a driving force to steering linkage 208 when actuated. For example, forcing mechanism 302 may include a pyrotechnic, hydraulic, or gas actuated piston that drives steering linkage 208 into wheel 110, causing the rearward end of the wheel to be rotated away from the vehicle during a small overlap frontal collision. Notably, and as described in greater detail below, such a rotation changes the potential force path for the impact force, thereby directing the impact force away from the door region of the vehicle. In various embodiments, forcing mechanism 302 may be affixed to steering linkage 208 externally (e.g., via an “L” shaped connection, etc.), located at an end of linkage 208 (e.g., between steering linkage 208 and gear box 206), or integrated therein. Forcing mechanism 302 may also be located at any point along linkage 208, in various embodiments.

A wheel twist system 300 for small overlap frontal collisions is shown in FIG. 3B, according to various embodiments. In general, forcing mechanism 302 may be of a telescoping design and include an outer housing 310 and an inner actuator arm 312 located at least partially within an aperture of housing 310. In other words, forcing mechanism 302 may be a telescopic linkage that is operable to extend actuator arm 312, thereby forcing linkage 208 into tire 110.

Housing 310 may be of a generally cylindrical shape, in one embodiment. In other embodiments, housing 310 may be of another geometric shape such as, but not limited to, a triangular tube, a square tube, a pentagonal tube, etc. Actuator arm 312 may be coupled to, or be integrated with, a piston 308 that resides internal to housing 310. When forcing mechanism 302 is actuated, pressure within housing 310 against piston 308 may create the driving force F, thereby forcing actuator arm 312 to extend outward from housing 310. As shown, such a pressure may be created pyrotechnically, in one embodiment. For example, an igniter 304 may ignite a pyrotechnic ordinance 306, thereby creating pressure within housing 310 on piston 308 and driving actuator arm 312 outward from housing 310. Pyrotechnic actuation of forcing mechanism 302 may be well suited for collision applications, since there is typically a short amount of time available to react before the collision force is transferred into the wheel of the vehicle.

In various embodiments, system 300 includes a controller 350 that generally comprises one or more processors 352, one or more memories 354, and one or more interfaces 356 in communication with one another via a bus 358. Processor 352 may include, but is not limited to, microprocessors, application specific integrated circuits (ASICs), or any other circuitry configured to perform logical operations. Memory 354 may store the machine instructions that, when executed by a processor 352, cause processor 352 to perform the operations described herein. Memory 354 may include, but is not limited to, hard drives, random access memory (RAM), read only memory (ROM), solid state storage devices, removable media (e.g., a CD, DVD, etc.), or any other non-transitory computer readable media operable to store the instructions for execution by processor 352.

Interfaces 356 provide the wired and/or wireless connections between controller 350 and any number of other devices located within the vehicle. For example, as shown, interfaces 356 may provide a communication link between controller 350 and any number of collision sensors 340 located in the vehicle. According to various embodiments, sensors 340 are located on the vehicle along a force path that corresponds to a small overlap frontal collision (e.g., within 20% of the width of the vehicle relative to a side of the vehicle). For example, one or more of sensors 340 may be located within a crush zone of the vehicle that would typically receive an impact force during a small overlap frontal collision.

Controller 350 may determine that a small overlap frontal collision of the vehicle has occurred based on data received from sensors 340. For example, in some embodiments, controller 350 may be an airbag control unit that receives impact data from any number of collision sensors 340 located in the front of the vehicle (e.g., to determine when the airbags of the vehicle should be deployed). If those of sensors 340 located closest to one side of the vehicle are triggered by the impact and more centrally-located sensors 340 along the front of the vehicle are not triggered, controller 350 may determine that a small overlap frontal collision has occurred.

In response to determining that a small overlap frontal collision has been detected, controller 350 may provide a control signal to forcing mechanism 302 that causes actuation of actuator arm 312. For example, controller 350 may arm igniter 304 via the control signal, thereby causing actuation of actuator arm 312 and twisting of the vehicle's wheel. An example of such an actuation is shown in FIG. 3C. As shown, the resulting force F generated by actuating forcing mechanism 302 (e.g., by telescoping forcing mechanism 302) may be transferred to steering linkage 208, thereby causing wheel 110 to turn about an axis defined by busing 214 coupled to control arm 210. In various embodiments, the direction of rotation of tire 110 may be such that the end of the wheel closest to the impact is rotated inward towards the vehicle and the end of the wheel more distal to the impact is rotated away from the vehicle (e.g., is turned out of the wheel well). In some cases, force F may be such that steering linkage 208 is disconnected from the rest of the steering rack when forcing mechanism 302 is actuated (e.g., disconnected from steering gear box 206, etc.), thereby maximizing the potential amount of rotation of tire 110.

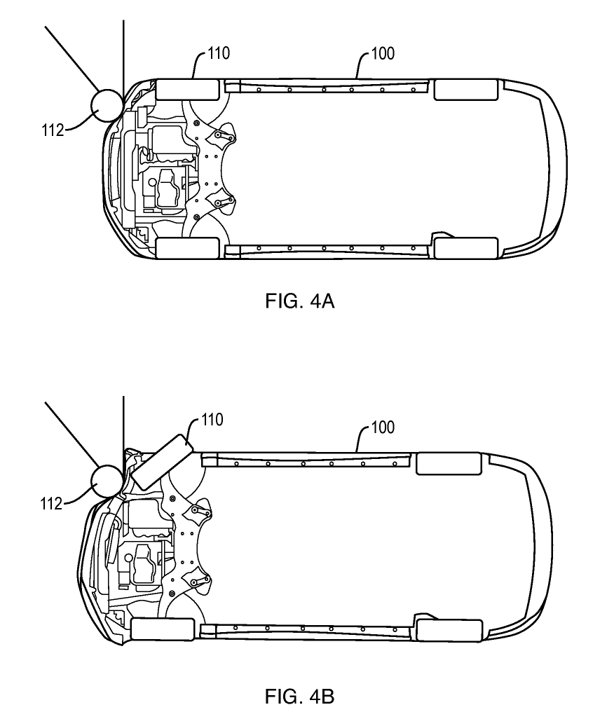

FIGS. 4A-4B are diagrams illustrating a small overlap frontal collision on vehicle 100 when equipped with wheel twist system 300, according to various embodiments. As shown in FIG. 4A, one or more sensors 340 positioned in the front end of vehicle 100 may detect a small overlap frontal collision with object 112. For example, at 5 ms after impact, one or more of sensors 340 may send sensor data to controller 350 that indicates detection of an impact. In response, controller 350 may determine that a small overlap frontal collision has been detected and actuate forcing mechanism 302. The effects of the impact on vehicle 100 after 20 ms is shown in FIG. 4B. As shown, wheel 110 may be forcibly twisted by forcing mechanism 302 such that the end of wheel 110 that is farther from the impact is twisted out of the wheel well and away from the body of vehicle 100. In doing so, wheel 110 no longer provides a direct force path between object 112 and the hinge column/door sill of vehicle 100, thereby reducing the amount of crumpling within the door region of the vehicle.

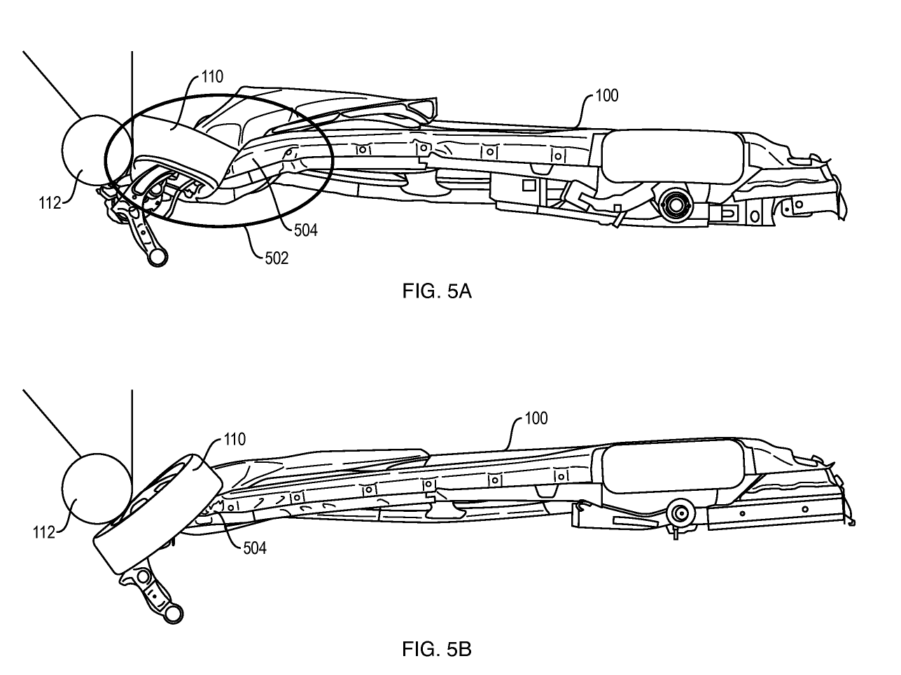

FIGS. 5A-5B are diagrams illustrating the underside of a vehicle during small overlap frontal collisions, in various embodiments. A simulation is shown in FIG. 5A of a small overlap frontal collision to vehicle 100 without wheel twist system 300. As shown, the impact force generated by vehicle 100 colliding with object 112 is transferred along wheel 110 into door sill 504 and the door hinge column of vehicle 100, thereby causing crumpling 502. In other words, in a typical small overlap frontal collision, wheel 110 provides a force path for the impact forces into the door region of vehicle 100.

FIG. 5B illustrates a small overlap collision with vehicle 100 while equipped with wheel twist system 300, according to one embodiment. In contrast to FIG. 5A, wheel twist system 300 may rotate wheel 110 away from door sill 504 in response to detecting the impact with object 112. In doing so, the crumpling 502 shown in FIG. 5A is prevented, thereby protecting against any impingement into the passenger compartment of vehicle 100.

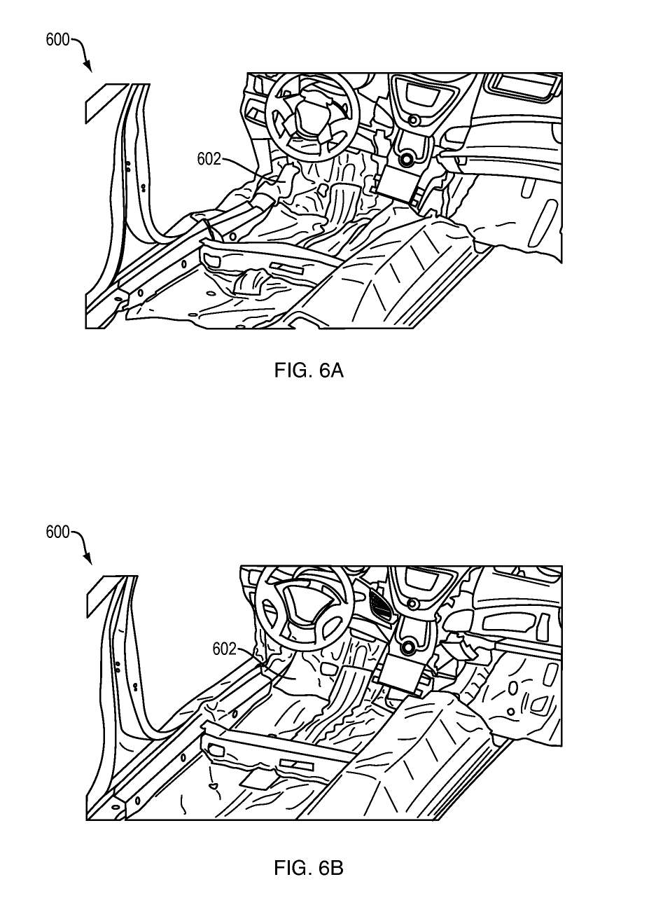

FIGS. 6A-6B are diagrams illustrating a vehicle passenger compartment 600 during small overlap frontal collisions, according to various embodiments. FIG. 6A corresponds to the impact depicted in FIG. 5A whereby vehicle 100 is not equipped with wheel twist system 300. As shown, crumpling 502 impinges on passenger compartment 600, particularly around region 602, where the driver's footrest is located. Thus, such a collision may potentially cause injury to the driver, since the structure of passenger compartment 600 has been compromised. As would be appreciated, a similar result may also occur on the passenger side of the vehicle, if the impact occurs on that side of the vehicle, instead. In FIG. 6B, passenger compartment 600 is shown when vehicle 100 is equipped with wheel twist system 300 and corresponds to the impact depicted in FIG. 5B. Notably, by twisting wheel 110 away from the door area of the vehicle, the amount of damage to area 602 is greatly reduced and potentially protecting the occupant from injury.

Various testing methods have been proposed to evaluate the structural performance of a vehicle during a small overlap frontal collision. One such standard of testing is the “Small Overlap Frontal Crashworthiness Evaluation Crash Test Protocol (Version II)” promulgated by the Insurance Institute for Highway Safety (IIHS) in December 2012 in which only 25%+/−1% of the width of a vehicle impacts a barrier during testing. Under the protocol, measurements are taken during the collision at various points along the vehicle to assess the intrusion into the passenger compartment of the vehicle. For example, intrusion measurements under the IIHS protocol may be taken at the steering column, lower left instrument panel, brake pedal, parking brake pedal, left footrest, two rear seat bolts that anchor the seat of the driver to the floor, left toepan, upper dash, lower and upper hinge pillar (e.g., for a total of six points along the hinge pillar/A-pillar of the vehicle), and at points along the rocker panel of the vehicle. The amount of intrusion at each point may then be assessed, to determine whether the vehicle exhibits good structural performance during the test. For example, an intrusion of 0-15 centimeters (cm) at the lower hinge pillar into the passenger compartment may be considered to be “good,” 15-22.5 cm to be “acceptable,” 22.5-30 cm to be “marginal,” and 35+cm to be “poor.”

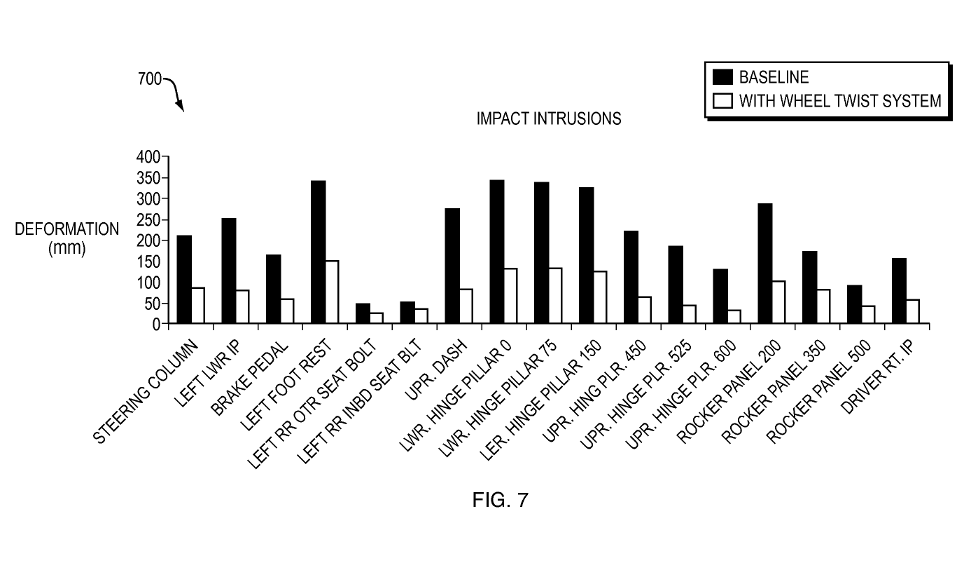

FIG. 7 illustrates simulated impact intrusion results for a vehicle, according to various embodiments. As shown in graph 700, the amount of deformation at various points in the vehicle is plotted for both a baseline vehicle and for the same vehicle equipped with wheel twist system 300. As would be appreciated, the simulations indicate that a wheel twist system such as system 300 may greatly reduce the amount of deformation across all of the IIHS-defined points along the vehicle. In addition, the maximum amount of intrusion into the passenger compartment was also greatly reduced during simulation when the vehicle was equipped with a wheel twist system.

Accordingly, techniques are described herein that have been shown in simulations to significantly improve the structural integrity of a vehicle during a small overlap frontal collision. In particular, a wheel twist system may forcibly cause the front wheel of the vehicle in line with the impact to be displaced such that the wheel no longer provides a force path into the hinge pillar/door sill of the vehicle.

While the embodiment of the present disclosure has been described in detail, the scope of the right of the present disclosure is not limited to the above-described embodiment, and various modifications and improved forms by those skilled in the art who use the basic concept of the present disclosure defined in the appended claims also belong to the scope of the right of the present disclosure.

What is claimed is:

1. A system comprising:
a telescopic linkage coupled to a wheel of a vehicle;
a sensor that detects a small overlap frontal collision of the vehicle; and
a controller coupled to the sensor and to the telescopic linkage, wherein the controller actuates the telescopic linkage in response to receiving an indication from the sensor that a small overlap frontal collision of the vehicle is detected, and wherein the telescopic linkage rotates the wheel when actuated by the controller.

2. The system as in claim 1, wherein the telescopic linkage rotates an end of the wheel that is closer to the collision in a direction towards the vehicle when actuated.

3. The system as in claim 1, wherein the telescopic linkage is a pyrotechnic linkage.

4. The system as in claim 3, wherein the telescopic linkage comprises:
a housing that defines an internal aperture;
an actuator arm coupled to the wheel and located within the internal aperture;
a piston coupled to the actuator arm;
an ordinance located within the internal aperture of the housing; and
an igniter operable to ignite the ordinance.

5. The system as in claim 1, wherein the controller is an airbag control unit.

6. The system as in claim 1, further comprising:
a steering rod that links the wheel to a steering gear box, wherein the telescopic linkage disconnects the steering rod from the steering gear box when actuated.

7. The system as in claim 1, wherein the telescopic linkage is actuated within 20 milliseconds of the sensor detecting the small overlap frontal collision of the vehicle.

8. The system as in claim 1, wherein the wheel rotates about an axis defined by a control arm connected to the wheel.

9. A method, comprising:
receiving, at controller, impact data from one or more sensors of a vehicle;
detecting, by the controller, a small overlap frontal collision of the vehicle; and
actuating, by the controller, a telescopic linkage coupled to a wheel of the vehicle, wherein the telescopic linkage rotates the wheel when actuated.

10. The method as in claim 9, wherein the telescopic linkage rotates an end of the wheel that is closer to the collision in a direction towards the vehicle when actuated.

11. The method as in claim 9, wherein the telescopic linkage is a pyrotechnic linkage.

12. The method as in claim 9, wherein the telescopic linkage comprises:
a housing that defines an internal aperture;
an actuator arm coupled to the wheel and located within the internal aperture;
a piston coupled to the actuator arm;
an ordinance located within the internal aperture of the housing; and
an igniter operable to ignite the ordinance.

13. The method as in claim 9, wherein the controller is an airbag control unit.

14. The method as in claim 9, wherein the telescopic linkage disconnects a steering rod from a steering gear box when actuated.

15. The method as in claim 9, wherein the telescopic linkage is actuated within 20 milliseconds of the sensor detecting the small overlap frontal collision of the vehicle.

16. The method as in claim 9, wherein the wheel rotates about an axis defined by a control arm connected to the wheel.

17. A system comprising:
sensing means for sensing a small overlap frontal collision of a vehicle;
forcing means for forcing a wheel of the vehicle to turn; and
controlling means for actuating the forcing means in response to the sensing means sensing the small overlap frontal collision of the vehicle.

18. The system as in claim 17, further comprising:
steering means for steering the wheel.

19. The system as in claim 18, further comprising:
disconnecting means for disconnecting the steering means from the wheel.

20. The system as in claim 19, further comprising:
retaining means for coupling the wheel to the vehicle while the forcing means is actuated.
